(19) United States
(12) Patent Application Publication
(10) Pub. No.: US 2017/0123112 A1
(43) Pub. Date: May 4, 2017

(54) Multilayered Press Stable Lens Array Film

(71) Applicants: Joel Scott Scarbrough, Lindenhurst, IL (US); David Eric Roberts, Avoca, WI (US)

(72) Inventors: Joel Scott Scarbrough, Lindenhurst, IL (US); David Eric Roberts, Avoca, WI (US)

(21) Appl. No.: 14/925,866

(22) Filed: Oct. 28, 2015

(51) Int. Cl. G02B 3/00; B42D 25/29; D21H 21/48; G02B 3/08

(52) U.S. Cl. CPC G02B 3/005; G02B 3/0031; G02B 3/08; B42D 25/29; D21H 21/48

(57) ABSTRACT

A thin film containing a lens array on at least a portion of the surface consisting of a multilayered transparent polymer substrate exhibiting good flexibility and superior thermo-mechanical resistance to tension, heat, and humidity conditions wherein the total thickness of the thin film is at least half the focal length of the lens array.

### FIELD OF THE INVENTION

The present invention relates generally to a thin multilayer lens array film structure that provides improved dimensional stability and economy for web printing animated and dimensional effects for high end or security labeling and packaging.

### BACKGROUND OF INVENTION

Printed animated and dimensional effects produced from lens arrays provide aesthetically appealing imagery to consumer products and packages. Further, when properly implemented; high resolution and very thin printed lens arrays add an effective and valuable authentication component to postage and excise stamps, valuable products, identification, security labels, high end consumer packaging, and financial instruments.

Producing animated and dimensional effects from lens arrays registered to specially prepared printed imagery is well known in the art. The most common methods use “lenticular” arrays of cylindrical lenses. Less common is the use of an “integral” arrays of spherical lenses, also known as fly's-eye lens arrays. Numerous methods incorporate many closely packed plano-convex lenses, analogous Fresnel type lenses, diffraction based lenses and prismatic lenses, in various arrangements, formed on the first side of a transparent polymeric material produced in sheet or web form (hereinafter “lens array material”).

Lens array materials are typically manufactured using a wide range of substantially transparent polymeric materials, whereby the lens array surface is formed to a first side of the material, and the opposing second side of the material is formed to be flat, generally a glossy surface. Printed imagery is typically applied to or printed onto the glossy surface. A very smooth, high gloss surface with surface tension characteristics and chemical moieties suited for the reception of inks is required for high resolution printing or applying of imagery. The overall thickness of the lens array material is typically manufactured to be at, or near, the focal plane of the lenses on the first side, such that the lenses focus on the second side glossy surface for subsequent printing or affixing of printed imagery; but this thickness is not always necessary as even at half the focal length, many animated and dimensional effects are possible.

Such materials have been manufactured in a variety of ways by generally embossing the lens array pattern into a transparent polymeric material using an reverse patterned engraved lens array embossing roll including; embossing into an extruded resin using a sheet extrusion or cast extrusion process (see for example U.S. Pat. No. 3,241,429 and U.S. patent application Ser. No. 12/111,455), embossing into a liquid resin, that is subsequently cured and hardened using radiation, curing the liquid resin onto a transparent polymeric base film while in direct contact with a cylinder engraved with the negative of the desired lens array (see for example U.S. Pat. Nos. 4,414,316, 4,420,527, 5,266,995, 5,330,799 and 5,554,432), and embossing or forming onto a extruded resin or onto a transparent polymeric base film (see for example U.S. Pat. Nos. 5,362,351 and 6,373,636).

Many applications, including security printing applications, require a very thin lens array material of about 25 to 200 microns in total thickness. Material of this gauge is too thin to produce using the prior art sheet extrusion method taught in U.S. Pat. No. 3,241,429. The cast extrusion method, taught in U.S. Ser. No. 12/111,455, can produce a lens array material of this gauge, but the single layer construction is too soft and dimensionally unstable to allow for accurate lens embossing, good lens geometry and subsequent accurate color to color registration of a web printing process. At this gauge such materials are known to stretch or distort under common web printing press tension, heat, pressure and humidity. Further, the side of the material opposite the lens array surface is normally formed by a rubber roll in the cast extrusion method, imparting a non-gloss surface which inhibits high resolution printing.

To add dimensional stability to thin lens array films, one manufacturing method has been described where they form the lenses by casting from UV curable resin in direct contact with a reverse lens array engraved cylinder onto biaxially oriented films, where the biaxial orientation of the polymer chains provides more dimensionally stability than non-oriented films due to the orienting and annealing process. The preferred biaxially oriented film used in prior art UV casting methods (U.S. Pat. Nos. 4,414,316, 4,420,527, 5,266,995, 5,330,799 and 5,554,432) is biaxially oriented polyethylene terephthalate (“BOPET”) where polyolefin's have been specifically disclaimed. There are several drawbacks in using BOPET film. Firstly, it is very expensive compared to other commodity type oriented clear films used in packaging, particularly polyolefin's such as biaxially oriented polypropylene (BOPP), biaxially oriented polyethylene (BOPE), or biaxially oriented polystyrene (BOPS). Secondly, polyethylene terephthalate is hygroscopic, and will change dimensions with changes in relative humidity. Such dimensional changes are especially challenging when printing on materials with very high frequency lens arrays, as any dimensional change of the material, however slight, will cause registration of the printing to be in misalignment with the lenses. Polymers like polypropylene, polyethylene, and polystyrene are substantially non-hygroscopic and therefore significantly more stable under changes in humidity. Thirdly, BOPET is considerably denser than BOPP, BOPE or BOPS, which adds additional costs and undesirable weight to the finished products. Fourthly, BOPET is a very rigid plastic, not flexible enough for label application to curved surfaces and for high speed application onto goods in automatic labeling lines.

Simple substitution of BOPP, BOPE or BOPS film, instead of BOPET in the UV casting method of the '636 patent is still undesirable. Although UV casting the lens array surface onto a base layer of BOPP, BOPE or BOPS films can likely be made to work with a suitable surface treatment of the film prior to UV casting, the UV casting resin is multiple times more expensive than the cost of the base film, restricting the wide spread use of such a label. Additionally, UV curable resins shrink during the curing process resulting in undesirable curl in the finished lens array material because the base layer will not shrink. Also, UV Resins are not compatible with the recycling chain of BOPP, BPOE, or BOPS film, and having a thin lens array film made entirely from recyclable olefins is highly desirable.

The biaxially oriented film specified in the method of extruding resin onto a transparent polymeric base film (U.S. Pat. Nos. 5,362,351 and 6,373,636) is again “BOPET, Polycarbonate, or acrylic,” and specifically '636 specifically states “(s)tarting films with the cited properties are critical to the accomplishments of my invention” where the BOPP, BOPE, and BOPS we claim in this invention possess substantially less “tensile strength under 5% elongation” which the '636 invention teaches away from. The '636 invention continues to have several other disadvantages; Using our method over the UV casting method solves the very high cost of utilizing a UV casting resin. BOPET is generally considered a high cost engineering grade film, compared to lower density, more commodity based films such as BOPP, BOPE or BOPS. Incurring unnecessary costs by requiring an added step of adhering the lens array layer to the BOPET film using a “sprayed” or “coated” adhesive or from an added secondary step in a manufacturing process, where such an added step has its own set of parameters and specifications, including optimal application speed, cure time, optimal ambient temperature, humidity and manufacturing costs etc., which may not be compatible to traditional manufacturing of lens array materials as it adds cost and demands compromises to each step. Also, the use of a traditional non-oriented adhesive detracts from the thermo-mechanical stability of the finished lens array material and inherently does not allow for recycling, as none of these types of sprayed or coated adhesives consist entirely of polypropylene, polyethylene, or polystyrene. Additionally, these adhesives commonly produce curl when the adhesive contracts or expands on cure, when the chemically different adhesive reacts different to post extrusion crystallization (shrinkage), and under different temperatures and humidity's. Also, these adhesives are generally pressure sensitive adhesives, which when slit expose the sticky adhesive to dirt, dust, and can allow for the lens surface to change dimension and slide relative to the BOP ET layer.

The '636 patent also describes the purpose of the biaxially oriented base film is to prevent distortion of the lens array from stresses imparted by a subsequent pull roll in an extrusion process, and which may not be stripped away from the extruded lens array after the lens array has cured via actinic radiation or heat dissipation. There remains a need for a thin film multilayered lens array film with thermo-mechanical characteristics to resist tension, pressure, heat, and humidity conditions of web printing, where the biaxial orientation is not purposed for the extrusion process, but the web printing process; where the construction possesses the thermo-mechanical dimensional stability required for web printing combined with the high flexibility required for labeling applications.

### OBJECT OF THE INVENTION

Considering the limitations of earlier methods of producing thin lens array film structures, a film structure is needed that; has a thickness of about 25 to 200 microns, is dimensionally stable during the embossing process, is dimensionally stable to allow accurate registration of printing to the lens array for high resolution printing under temperatures and stresses incurred under subsequent web printing, is made from non-hygroscopic materials, is manufactured from economical component layers, is flexible for ease of labeling application yet has sufficient thickness to allow for reasonably low frequency lenses, which therefore do not require extremely rare resolutions, has a high gloss print surface suitable for high resolution printing, has a thermo-bonding layer that is preferably biaxially oriented, and where the lens array is formed onto a highly flexible transparent polymeric material and bonded to a biaxially oriented press stable base layer, preferably in a single operation to optimize the economies and quality of the lens formatting step, and optionally contains a formed or colorized pattern on the flat surface opposite the lens array of a alignment and frequency within a few percentage points of alignment and frequency of the lens array to cause a three-dimensional moiré to be visible when viewed through the lens array.

Such a lens array material is of high interest to the label printing industry in general, and especially the brand authentication and security printing markets; as covert and overt optical effects from thin materials are generally considered a valuable security feature to authenticate products and financial instruments and discourage counterfeiting, (for example, the use of an lens array ribbon film embedded in the US $100 dollar bill)

These and other objects of this invention have been achieved after extensive trial and error; one object is to provide a multilayer lens array film with a thickness of about 25 to 200 microns with good dimensional stability that is non-hygroscopic, for improved press registration of high resolution printing on web printing presses.

In accordance with various embodiments of the invention, biaxially oriented base film is produced by stretching a cast or blown film both in the machine and transverse direction. The films are thermally stabilized through annealing ovens during and after stretching. Stretching the film orients the polymer chains in the machine and transverse directions; this orientation is responsible for increased stiffness, thermo-mechanical dimensional stability, enhanced clarity and improved barrier properties.

In accordance with various embodiments to the invention, one preferred embodiment provides a multilayered lens array film structure, with sufficient focal length for relatively lower lens frequency enabling highly detailed three-dimensional effects using commonly available print resolutions, flexibility for labeling applications, e.g. conforming to curved surfaces, yet be thermo-mechanically stable for dimensional stability during web printing, which includes: (I) an outwardly facing transparent highly flexible non-oriented polypropylene, polyethylene or polystyrene layer embossed with a lens array surface formed thereon; (II) a low melt polyolefin thermo-bonding layer, preferably biaxially oriented, (III) a non-hygroscopic biaxially oriented press stable polypropylene, polyethylene or polystyrene base layer; (IV) preferably with an optional outwardly facing print receptive polymer layer to enhance printability of the film, also preferably biaxially oriented, and optionally wherein all layers consist of the same polymer so the construction is suitable for recycling.

In a single step extrusion embodiment, raw thermoplastic material in the form of small beads (often called “resin”, “pellets” or “chips” in the industry) is gravity fed from a top mounted hopper into the barrel of the extruder. Additives are often used and can be mixed into the resin prior to arriving at the hopper or in the extrusion process. Such additives improve the performance of the plastic, including nucleating agents used to clarify the material and reduce secondary crystallization effects (shrinkage). The resin enters through the feed throat (an opening near the rear of the barrel) and comes into contact with the screw. The rotating screw (normally turning at up to 120 rpm) forces the plastic beads forward into the barrel which is heated to the desired melt temperature of the resin (which can range from 200° C. to 275° C. depending on the polymer). The resin is heated both by the barrel heaters and the intense pressure and friction taking place inside the barrel. At the front of the barrel, the molten plastic leaves the screw and travels through a screen pack to remove any contaminants in the melt. After passing through the breaker plate molten plastic enters the die. The die is what gives the final non-oriented surface polymer layer its gauge profile. At this point the press stable base layer consisting essentially of a transparent biaxially oriented press stable layer and a transparent thermoplastic thermo-bonding polymer layer, is unwound and fed into the extrusion line where the molten non-oriented polymer surface layer is cast from the die directly onto the thermo-bonding layer, such that the heat of the molten cast surface polymer causes the thermo-bond layer to melt and while the non-oriented surface polymer is still molten, this multilayered lens array film is brought into direct contact with a chilled reverse lens array engraved cylinder (“lens forming chill roll”), which causes cooling and solidification of the thermoplastic surface polymer, thus forming a secure bond with the thermo-bond layer and imparting the outwardly facing surface relief lens array pattern.

In accordance with various embodiments of the invention, after extruding and thermo-bonding the lens array film structure, the material is wound to a roll form and allowed to gradually cool and stabilize to complete the crystallization process.

In one embodiment, the print receptive surface of the multilayered press stable lens array substrate has a highly polished finish and contains chemical moieties to significantly enhance print reception and ink adhesion above and beyond traditional corona treated polyolefin surfaces.

In one preferred embodiment, the lens array surface layer is composed of polypropylene, polyethylene, or polystyrene, or a blend of said polymers.

In accordance with a multi-step process, the formation of the lens array surface relief structures is conducted secondarily, after the surface polymer is thermo-bonded to the base layer and cooled to form a secure bond, by methods commonly known in the arts, such as forming, embossing, or printing.

In accordance with another embodiment, the multilayered press stable lens array substrate is further converted into thin ribbon material and inserted into paper bank notes.

In accordance with another embodiment, the multilayered press stable lens array substrate is formed with select lens array areas and substantially flat non-lens array areas and further converted into polymer bank notes.

In accordance with various embodiments of the invention, the lens array surface can include refractive lens arrays, Fresnel lens arrays, diffractive lens arrays, prismatic lens arrays and any combination thereof and be formed over the entire surface of the lens array layer, or in discrete, selective areas, as per any engraving is done to the lens forming chill roll.

In accordance with another embodiment of this invention, a formed or colorized pattern is applied onto the flat surface opposite the lens array with an alignment and frequency within a few percentage points of alignment and frequency of the lens array to cause a three-dimensional moiré to be visible when viewed through the lens array.

In accordance with another embodiment, a colorized pattern is applied to the flat surface opposite the lens array, wherein the colors chosen are typical camouflage colors, and are applied in relation to the lens array such that the colors of discrete regions change with viewing angle; so as to reduce the visibility from human, animal and wavelength observation of people, buildings, vehicles behind this living camouflage.

In accordance with various embodiments of the invention, the biaxially oriented adhesive thermo-bonding layer generally has thickness of less than about 25 microns.

In another embodiment, the biaxially oriented adhesive thermo-bonding layer is generally composed of polyolefin's with a molecular weight with a melt temperature to bond securely to the non-oriented cast extruded molten polymer and insure adhesion. Additional components can include styrene, vinyl, ester, alcohol groups, and the like, to raise surface tension and increase the bond strength between the cast and oriented layers.

In another preferred embodiment, the combined thickness of the lens array layer, the biaxially oriented thermo-bonding layer, and the biaxially oriented film layer is between about 25 and 200 microns, and corresponds to at least half the focal length of the lenses of the outwardly facing lens array surface.

In another preferred embodiment, the multilayered press stable lens array consists of linear or cylindrical lenses contain between 150 and 400 lenses per linear inch, and the total thickness of the construction is between 75 and 200 microns thick.

### BRIEF DESCRIPTION OF DRAWINGS

FIG. 1 is a side elevation schematic view of one embodiment of the multilayered flexible lens array.

FIG. 2 is a side elevation schematic view of another embodiment of the multilayered flexible lens array with a print receptive polymer layer.

FIG. 3 is a side elevation schematic view of another embodiment of the multilayered flexible lens array with a formed pattern in the base layer.

FIG. 4 is a side elevation schematic view of another embodiment of the multilayered flexible lens array with a formed pattern in the print receptive polymer layer.

FIG. 5 is a side elevation schematic view of another embodiment of the multilayered flexible lens array with a colorized pattern formed onto the base layer.

FIG. 6 is a side elevation schematic view of another embodiment of the multilayered flexible lens array with a colorized pattern formed in the print receptive polymer layer.

### DETAILED DESCRIPTION

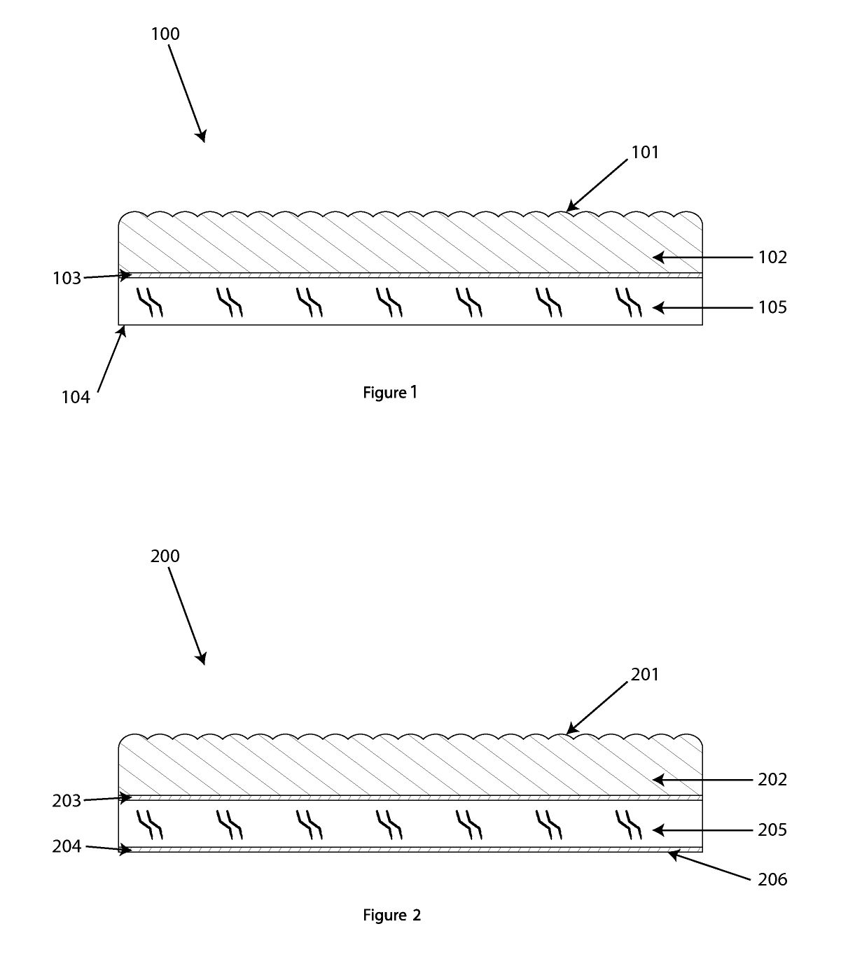

FIG. 1 is an example of one embodiment of the disclosure: a thin, dimensionally stable, multilayer, flexible, press stable lens array film structure (100), providing an outer facing lens array surface layer (102) made of a transparent polymeric highly flexible non-oriented material, having a first and second side, where the first side includes a printed, formed, or embossed outwardly facing lens array relief surface (101), and the second side is bonded to a biaxially oriented thermo-mechanically dimensionally press stable transparent polymeric base layer (105), by using heat and pressure which melts a transparent thermo-bonding polymer layer (103) which is an integral co-extruded top layer of the press stable polymeric base layer (105), where a gloss surface is imparted onto the polymeric base layer (104) to assist in high resolution printing.

FIG. 2 shows another embodiment of the disclosure: a thin, dimensionally stable, multilayer, flexible, press stable lens array film structure (200), providing an outer facing lens array surface layer (202) made of a transparent polymeric highly flexible non-oriented material, having a first and second side, where the first side includes a printed, formed, or embossed outwardly facing lens array relief surface (201), and the second side is bonded to a biaxially oriented polymeric thermo-bonding layer (203), which is an integral co-extruded top layer of a biaxially oriented thermo-mechanically dimensionally press stable polymeric base layer (205), and a print receptive layer (204) consisting of a biaxially oriented polymer possessing surface characteristics specifically engineered to be receptive to high resolution printing (206), and is preferably glossy to assist in high resolution printing.

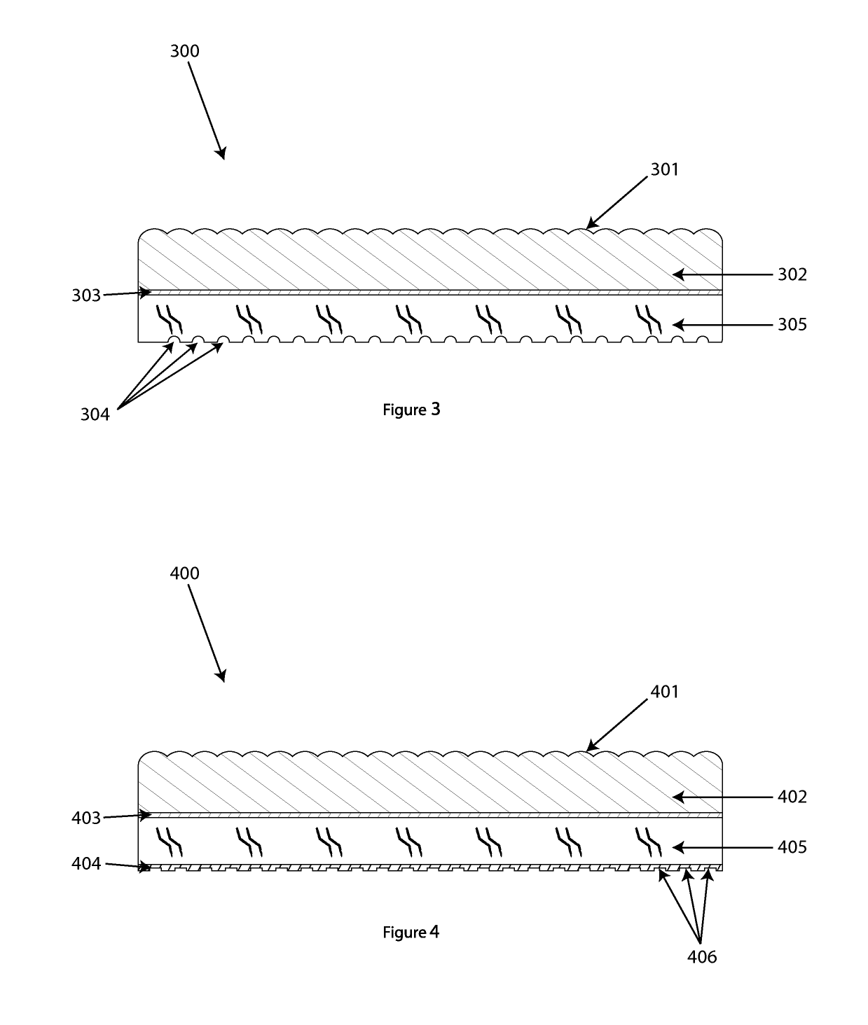

FIG. 3 shows another embodiment of the disclosure: a thin, dimensionally stable, multilayer, flexible, press stable lens array film structure exhibiting a 3 dimensional visual effect when viewed through the lens array resulting from embossing a pattern substantially similar in frequency and arrangement but slightly different enough from the lens array to cause a three-dimensional moiré between the lens array and the embossed pattern (300), providing an outer facing lens array surface layer (302) made of a transparent polymeric highly flexible non-oriented material, having a first and second side, where the first side includes a printed, formed, or embossed outwardly facing lens array relief surface (301), and the second side is bonded to a biaxially oriented polymeric thermo-bonding layer (303), which is an integral co-extruded top layer of a biaxially oriented thermo-mechanically dimensionally press stable polymeric base layer (305), this biaxially oriented base layer being embossed by a relief pattern (304).

FIG. 4 shows another embodiment of the disclosure: a thin, dimensionally stable, multilayer, flexible, press stable lens array film structure exhibiting a three-dimensional visual effect when viewed through the lens array resulting from embossing a pattern substantially similar in frequency and arrangement but slightly different enough from the lens array to cause a three-dimensional moiré between the lens array and the embossed pattern (400). Providing an outer facing lens array surface layer (402) made of a transparent polymeric highly flexible non-oriented material, having a first and second side, where the first side includes a printed, formed, or embossed outwardly facing lens array relief surface (401), and the second side is bonded to a biaxially oriented polymeric thermo-bonding layer (403), which is an integral co-extruded top layer of a biaxially oriented thermo-mechanically dimensionally press stable polymeric base layer (405). A print receptive layer (404) consisting of an embossible polymer embossed by a relief pattern (406).

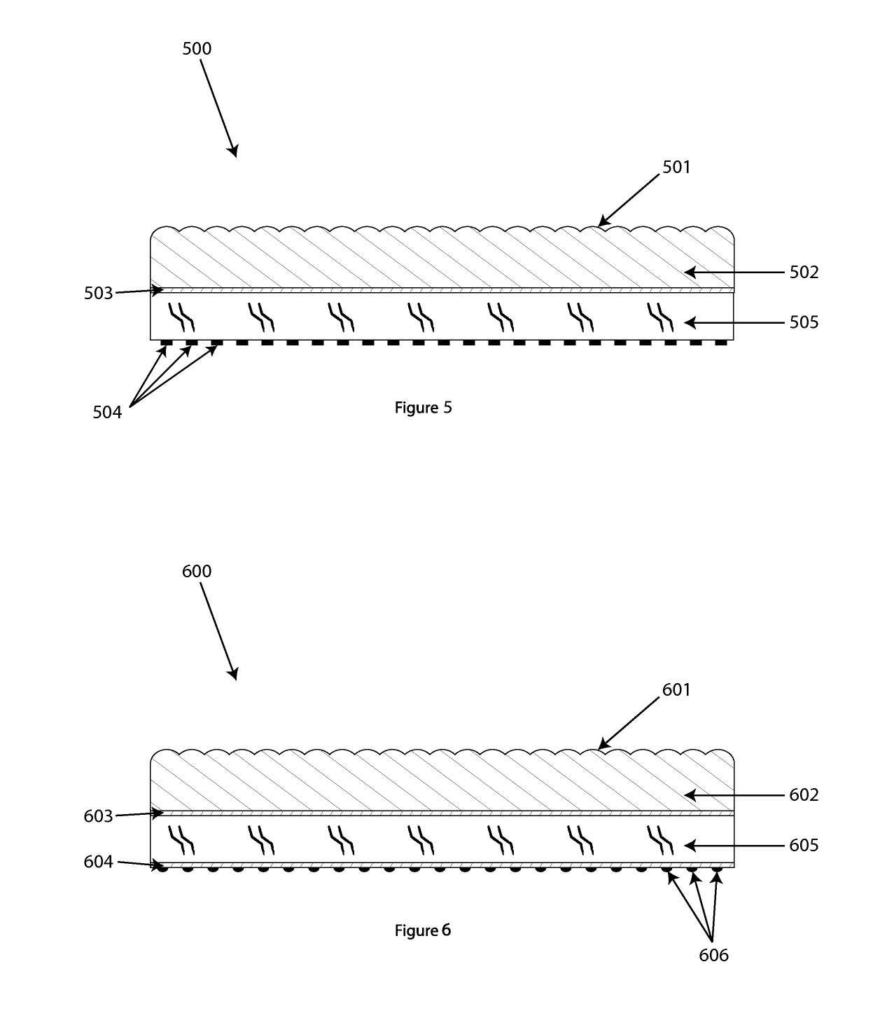

FIG. 5 shows another embodiment of the disclosure; a thin, dimensionally stable, multilayer, flexible, press stable lens array film structure exhibiting a 3 dimensional visual effect when viewed through the lens array resulting from embossing a pattern substantially similar in frequency and arrangement but slightly different enough from the lens array to cause a 3 dimensional moiré between the lens array and the embossed pattern (500). Providing an outer facing lens array surface layer (502) made of a transparent polymeric highly flexible non-oriented material, having a first and second side, where the first side includes a printed, formed, or embossed outwardly facing lens array relief surface (501), and the second side is bonded to a biaxially oriented polymeric thermo-bonding layer (503), which is an integral co-extruded top layer of a biaxially oriented thermo-mechanically dimensionally press stable polymeric base layer (505), and a colorized pattern substantially similar in frequency and arrangement but slightly different from the lens array formed thereon (504).

FIG. 6 shows another embodiment of the disclosure: a thin, dimensionally stable, multilayer, flexible, press stable lens array film structure exhibiting a 3 dimensional visual effect when viewed through the lens array resulting from colorized pattern substantially similar in frequency and arrangement but slightly different enough from the lens array to cause a three-dimensional moiré between the lens array and the embossed pattern (600). Providing an outer facing lens array surface layer (602) made of a transparent polymeric highly flexible non-oriented material, having a first and second side, where the first side includes a printed, formed, or embossed outwardly facing lens array relief surface (601), and the second side is bonded to a biaxially oriented polymeric thermo-bonding layer (603), which is an integral co-extruded top layer of a biaxially oriented thermo-mechanically dimensionally press stable polymeric base layer (605). A print receptive layer (604) consisting of a transparent or colorized polymer containing a transparent or colored pattern (606) substantially similar in frequency and arrangement but slightly different from the lens array formed thereon.

### SUMMARY OF THE INVENTION

The multilayered press stable lens array film described herein provides numerous advantages to the high end print market. Accordingly, one advantage of the present invention is to provide a multilayer lens array film with a thickness of about 25 to 200 microns with good dimensional stability from the biaxially oriented base layer that is non-hygroscopic for dimensional stability with improved press registration of each printing color for high resolution printing on web printing presses.

Another advantage of the present invention is to provide a lens array film that has a high gloss print receptive surface, opposite the side of the optical relief surface, to allow for high resolution printing to that surface.

Another advantage of the present invention is to provide a lens array film where the thermo-bonding polymer layer, between the outwardly facing lens array surface layer and the biaxially oriented base layer, is biaxially oriented for additional thermo-mechanical dimensional stability for web printing.

Another advantage of the present invention is to emboss the lens array surface and bond the lens array surface layer to the polymer thermo-bonding layer in a single manufacturing step.

Another advantage of the present invention is to have a lens array material consisting of a multilayered flexible press stable lens array film structure containing a pattern (colorized, embossed, or debossed) on the surface opposite and at least half the distance from the focal length of the lens array to achieve 3 dimensional effects when viewed through the lens array.

Another advantage of the present invention is to provide a lens array film that has a structure made from low cost commodity based components to be economically competitive with other label films, preferably where all layers of the film are composed of similar polymers for recyclability.

Another advantage of the present invention is to provide a lens array film that is not only highly dimensionally stable for web printing, but also highly flexible so as to be compatible with high speed automatic label applicators and easily wrap around curved surfaces.

Another advantage of the present disclosure is the multilayered press stable lens array has a unique combination of dimensional stability from biaxial orientated layer and flexibility of non-orientated layer providing a thin lens array material ideally suited for further conversion into thin ribbon security threads, such as are commonly used interwoven into bank notes.

Another advantage of the present disclosure is the multilayered press stable lens array has a unique combination of dimensional stability from biaxial orientated layer and flexibility of non-orientated layer provides a thin lens array material with excellent anti-crease and weather ability, and optional select lens non-lens areas making this material ideally suited for further conversion directly into polymer bank notes.

It is obvious to those skilled in the art that many of these layers are not always required, or could be added in preceding or secondary steps, and still be within the bounds of this invention.

In describing the embodiments of the invention illustrated in figures, specific terminology is used for the sake of clarity. However, the invention is not limited to the specific terms so selected, and each specific term at least includes all technical and functional equivalents that operate in a similar manner to accomplish a similar purpose.

The exemplary embodiments are only selected samples of the solutions available by combining the teachings referenced above. The solutions necessarily are not exhaustively described herein, but are fairly within the understanding of an artisan given the foregoing disclosure and familiarity with cited art. While the preferred and alternate embodiments of the invention have been described in detail, modifications may be made thereto, without departing from the spirit and scope of the invention as delineated in the following claims.

1. A multilayered flexible lens array substrate comprising:
a substantially planar press stable transparent base layer film with mechanical and thermal stability, wherein said base layer is composed essentially of a non-hygroscopic biaxially oriented polymer layer substantially juxtaposed to a thermoplastic thermo-bonding polymer layer, and
a substantially planar surface layer, wherein said surface layer is composed essentially of a transparent highly flexible non-oriented polymer, wherein one plane of said surface layer is affixed using heat and pressure to said thermo-bonding layer surface of said base layer, wherein the opposite plane of said surface layer is embossed, printed, or formed with a high frequency lens array of between 150 and 1000 lenses per linear inch, wherein the total thickness of said multilayered lens array substrate is at least half the focal length of said lens array, being between 25 and 200 microns.

2. A multilayered flexible lens array substrate comprising:
a substantially planar press stable transparent base layer film, wherein said base layer is composed essentially of a non-hygroscopic biaxially oriented polymer layer centrally juxtaposed between a thermoplastic thermo-bonding polymer layer on one surface and a ink receptive polymer layer on the opposite surface, and a substantially planar surface layer, wherein said surface layer is composed essentially of a highly flexible non-oriented transparent polymer, wherein one plane of said surface layer is bonded using heat and pressure to said thermo-bonding polymer layer surface of said base layer, wherein the opposite plane of said surface layer is embossed, printed, or formed with a high frequency lens array of between 150 and 1000 lenses per linear inch, wherein the total thickness of said multilayered lens array substrate is at least half the focal length of said lens array, being between 25 and 200 microns.

3. (canceled)

4. A multilayered flexible lens array as in claim 1, further wherein:
said surface layer is the same polymer as said base layer.

5. A multilayered flexible lens array substrate of claim 1 further wherein:
said lens array contains between 150 and 500 lenses per linear inch, and the total thickness is between 75 and 150 microns thick.

6. A multilayered flexible lens array substrate of claim 1 further wherein:
said lens array consists of any of the family of: linear cylindrical, hexagonal, Fresnel, diffraction, prismatic lenses, and combinations thereof.

7. A multilayered flexible lens array substrate of claim 1 further wherein:
a nucleating agent is added to the non-oriented surface layer polymer to reduce the amount of secondary crystallization of said surface layer polymer.

8. A multilayered flexible lens array substrate of claim 1 further wherein:
said base layer and said surface layer consist essentially of polypropylene or polyester.

9. A multilayered flexible lens array substrate of claim 2 further wherein:
a pattern with a substantially similar alignment and a frequency within a few percentage points of said lens array is formed onto said ink receptive layer at a distance of at least half the focal length of said lens array.

10. A multilayered flexible lens array substrate of claim 1 further wherein:
a colorized pattern with a substantially similar alignment and a frequency within a few percentage points of said lens array is formed onto said ink receptive layer at a distance of at least half the focal length of said lens array.

11. (canceled)

12. A multilayered flexible lens array substrate of claim 4 further wherein:
said thin film lens array is inserted into paper bank notes.

13. A multilayered flexible lens array substrate of claim 1 further wherein:
the multilayered lens array is converted into a polymer bank note.

14. A method for manufacturing a multilayered flexible lens array substrate comprising:
unwinding a roll of a substantially planar transparent base layer film material, wherein said base layer material is composed essentially of a biaxially oriented polymer layer substantially juxtaposed to a thermoplastic thermo-bonding polymer layer, and
bringing said thermo-bonding polymer layer of said base layer into contact under heat and pressure to a cast film of molten highly flexible transparent non-oriented surface layer polymer material, whereby one plane of said surface layer is then securely bonded to said thermo-bonding polymer layer, and
forming a lens array onto the opposite plane of said surface layer, wherein the total thickness of said flexible lens array substrate is at least half the focal length of said lens array.

15. A method of manufacturing a multilayered flexible lens array substrate comprising:
unwinding a roll of a substantially planar transparent base layer film material, wherein said base layer is composed essentially of a biaxially oriented polymer layer centrally juxtaposed between a thermoplastic thermo-bonding polymer layer and a ink receptive polymer layer, and
bringing said thermo-bonding layer into direct contact under heat and pressure to a cast film of molten surface layer material, wherein said surface layer is composed essentially of a highly flexible transparent non-oriented polymer, whereby one plane of said surface layer is then securely bonded to said thermo-bonding layer surface of said base layer, and
forming a lens array onto the opposite surface of said surface layer, wherein the total thickness of the flexible lens array substrate is at least half the focal length of said lens array.

16. A method of manufacturing a multilayered flexible lens array substrate as in claim 14 further wherein:
all layers of said multilayered flexible lens array are composed of the same polymer.

17. A method for manufacturing a multilayered flexible lens array substrate comprising:
unwinding a roll of a substantially planar biaxially oriented transparent base layer film material, wherein said base layer material is composed essentially of a biaxially oriented polymer layer substantially juxtaposed to a thermoplastic thermo-bonding layer, and
bringing said thermo-bonding layer of said base layer into contact under heat and pressure to a cast film of a molten surface layer material, whereby the surface layer consists essentially of a highly flexible non-oriented transparent polymer, wherein one plane of said surface layer is then securely bonded to said thermo-bonding layer, and
forming a lens array onto the opposite plane of said surface layer, wherein the lens array consists of between 200 to 1000 lenses per linear inch, and wherein the total thickness of the flexible lens array substrate is at least half the focal length of said lens array.

18. A method for manufacturing a multilayered flexible lens array substrate as in claim 14 further including:
wherein the lens array consists of Fresnel, prismatic, diffraction, linear, hexagonal, square packed lens arrays, or combinations thereof.

19. A method of manufacturing a multilayered flexible lens array as in claim 14 further including:
forming a pattern onto or into the surface of said base layer opposite said lens array, where said pattern has a frequency and alignment within a few percentage points of the frequency and alignment of said lens array.

20. A method of manufacturing a multilayered flexible lens array as in claim 14 further including:
applying a colorized pattern onto the surface of the base layer opposite the lens array which is within a few percentage points of the frequency and alignment of the lens array to cause a moiré.
